(19) United States
(12) Patent Application Publication
(10) Pub. No.: US 2003/0184499 A1
(43) Pub. Date: Oct. 2, 2003

(54) Display device for use in electronics device and light guide plate therefor

(76) Inventor: Ikuhito Miyashita, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/403,044

(22) Filed: Apr. 1, 2003

(30) Foreign Application Priority Data
Apr. 2, 2002 (JP) 2002-99955

(51) Int. Cl. G09G 3/00

(52) U.S. Cl. 345/30

(57) ABSTRACT

Disclosed is a display device for use in an electronics device comprising an equilateral triangular, light guide plate of a transparent material. The triangular plate has a recess formed on its apex and a plurality of windows formed on its bottom side, separated by masking at intervals. A single light source is placed in the recess of the triangular plate. The windows can be evenly illuminated by the diffused light from the single light source.

### BACKGROUND OF THE INVENTION

1. Field of the Invention

The present invention relates to a display device for use in an electronics device such as an HDD, giving pieces of information pertaining to the operation of the electronics device.

2. Related Art

FIG. 4 shows a combined device 12 including therein a VCR and an HDD. The device has a display 14 on its front panel 4, showing how the device is working. The display 14 is composed of a series of windows (illuminated sections) 11 each having an LED light source placed behind. Thus, all windows are illuminated.

This arrangement requires use of LEDs as many as the windows, and the work of mounting such numerous light sources into the display device is complicated, and accordingly the manufacturing cost is high. Still disadvantageously, all LEDs cannot have same intensity of light, thus causing the windows to be unevenly illuminated. All LEDs can be selected to radiate almost same strength of light, but this requires extra work leading to additional amount to the manufacturing cost.

FIGS. 5(a) and 5(b) show two conventional display versions each having a series of LED light sources 2 behind its windows. Specifically a printed circuit board 3 has a plurality of LED light sources 2 mounted thereon, and the printed circuit board 3 is placed behind the front panel 4 with the LED light sources 2 aligned with the windows 11 for illumination. As shown in FIG. 5a the windows 11 are formed by masking the front panel 4 at regular intervals on its inside, as indicated by 10. As seen from FIG. 5b, the front panel 4 has partition walls 15 formed on its inside, and the LED light sources 2 are put in these compartments, thereby confining the light within the closed spaces.

In either case, an electric power proportional to the number of the LEDs used is consumed. Also disadvantageously, there are a variety of problems caused by using plural light sources. In the hope of reducing such problems there has been proposed a display device whose light sources are reduced to possible minimum by making full use of reflection and dispersion of the light from the least number of light sources. JP09-007414A discloses a “linear light source”, which comprises: a rod-like light guide, two light emitting elements arranged at the opposite ends of the rod-like light guide and an “H” or “U”-shaped, trough-like frame holding the rod-like light guide with its light outlet side exposed. The rod-like light guide has a light-outlet surface and an inverted, flattened “V”-shaped light-reflection surface, confronting the overlying light-outlet surface. The inverted, flattened “V”-shaped light-reflection surface is composed of two opposite oblique light reflection surfaces with its apex directed toward the midpoint of the overlying light radiation surface.

JP11-284803A discloses a “linear light source unit”, which uses a triangular light-transparent plate having a triangular space formed therein with its apex directed toward the apex of the triangular plate, so that the light emitted from a light source placed on the apex of the triangular plate may reflect on the boundaries of the triangular space within the triangular plate for random reflection and dispersion. This arrangement, however, cannot cause even dispersion of the light from the light source, causing the windows to be unevenly illuminated. Another conventional art uses optical fibers as many as the windows to connect them to a single light source for conveying divisional amounts of the light, which is emitted from the single light source. The connecting of the windows to the single light source with the optical fibers requires a skillful, laborious work.

In view of the above one object of the present invention is to provide an improved display device for use in an electronics device, the display device being of simple structure, enabling a single light source to illuminate all windows evenly.

Another object of the present invention is to provide an improved light guide plate making the light from a single light source travel to all windows for even illumination.

### SUMMARY OF THE INVENTION

A display device for use in displaying how an electronics device works or what pieces of information are sent or received, comprises according to the present invention: a triangular, light guide plate of a transparent material, the triangular plate having a recess formed on its apex and a plurality of windows formed on its bottom side, separated by masking at intervals; and a light source placed in the recess of the triangular plate, whereby the windows may be illuminated by the light from the light source.

The recess may be finely irregular on its surface.

The triangular plate may be finely irregular on its oblique sides.

The triangular plate may be finely irregular on its bottom side to provide the finely irregular-surfaced windows.

The display device may further comprise a bottom plate, which is fastened to the bottom side of the triangular plate at right angles.

The triangular plate may have apertures made therein to make all windows to be evenly illuminated.

A light guide plate for guiding the light from a light source to the windows of a display device, thereby displaying how an electronics device works or what pieces of information are sent or received, comprises according to the present invention: a triangular plate of a transparent material, the triangular plate having a recess formed on its apex to contain the light source, the windows being formed on the bottom side of the triangular plate, separated by masking at intervals.

The recess, opposite oblique sides and bottom side of the triangular plate may be finely irregular on their surfaces.

The light guide plate may further comprise a bottom plate, which is fastened to the bottom side of the triangular plate at right angles.

The fine irregular surface of the recess has the effect of diffusing the light from the single light source in the triangular light-transparent plate, thereby evenly illuminating all windows. The fine irregular surfaces of the opposite oblique sides and bottom side of the triangular plate contributes to the even diffusion of the light from the single light source.

Other objects and advantages of the present invention will be understood from the following description of a display device using a light guide plate according to one preferred embodiment of the present invention, which display device is shown in accompanying drawings.

### BRIEF DESCRIPTION OF THE DRAWING

FIG. 1 illustrates a display device according to the present invention;

FIGS. 2(a) and 2(b) are perspective views of the display device as viewed from the top and bottom sides of the display device;

FIGS. 3(a), 3(b) and 3(c) show three recess versions (circular arc, elliptic and polygonal shapes) each made on the apex of the triangular plate;

FIG. 4 is a perspective view of an electronics device having a display provided on its front; and

FIGS. 5(a) and 5(b) illustrate conventional display devices.

### DETAILED DESCRIPTION OF PREFERRED EMBODIMENT

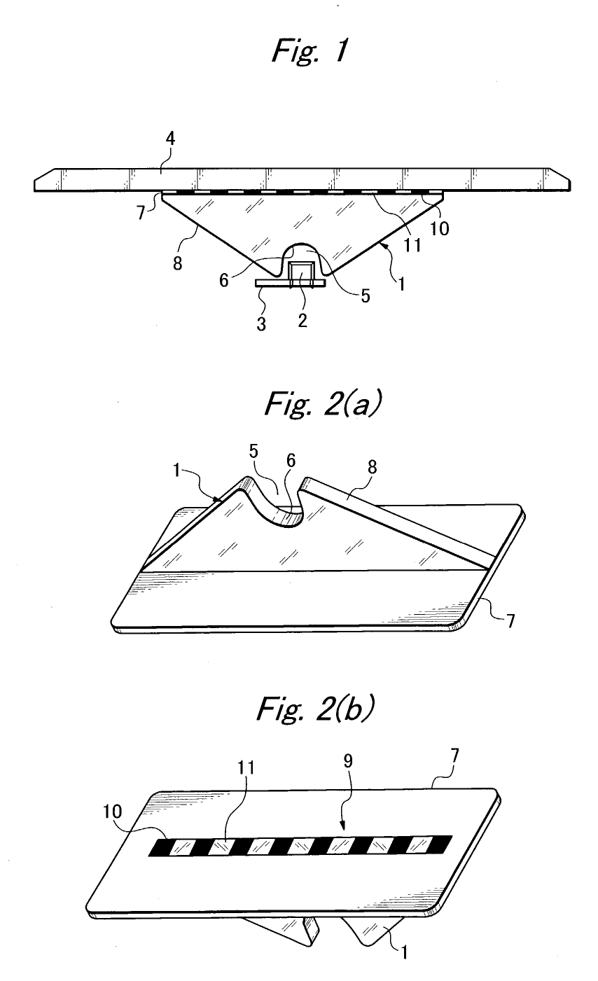

Referring to FIG. 1, a display device for use in displaying how an electronics device works or what pieces of information are sent or received, comprises a triangular, light guide plate of a transparent material 1, an LED light source 2 mounted on a printed circuit board 3 and a front panel 4.

The equilateral triangular plate 1 has a recess 5 formed on its apex, and the LED light source 2 is placed in the recess 5 so that the light from the LED light source 2 may be projected to the curved surface 6 of the recess 5, passing through the light-transparent guide plate 1 to illuminate the bottom plate 7. The bottom plate 7 has stripe coverings or coatings formed at regular intervals, thereby defining light-transparent windows 11 between adjacent masked areas.

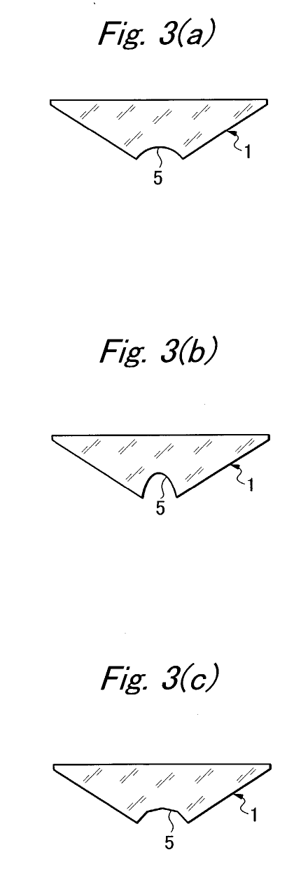

Referring to FIGS. 2(a) and 2(b), an equilateral triangular light guide 1 has a rectangular bottom plate 7 fixed to its bottom side at right angles. The equilateral triangular light guide 1 has a recess 5 made at its apex. The curved surface 6 of the recess 5, the surfaces 8 of the two oblique sides and the linear masked section 9 of the display surface of the bottom side of the triangular plate 1 are made finely irregular.

The finely irregular surface 6 of the recess 5 causes the light from the LED light source 2 to disperse within the triangular plate 1, partly reflecting from the oblique side surfaces for further diffusion, although a small portion of light is allowed to leak from the oblique sides. The amount of light reaching the bottom of the triangular plate 1 illuminate the linear masked section 9 of the display surface. Specifically the windows 11 delimited by the masked stripes 10 are illuminated with diffused light.

The windows 11 are made finely irregular, and therefore, the light passing through the windows 11 is diffused so that the light from each window may be projected from the front panel 4 in all directions, thus permitting the sight of every window to be seen from oblique angles relative to the front panel 4.

In FIGS. 2(a) and 2(b), the light guide plate 1 is shown as having the bottom plate 7 fastened to the bottom side of the light guide plate 1, thus facilitating the fixing of the light guide 1 to the rear side of the front panel 4. Instead, the light guide plate 1 can be fixed to the front panel 4 directly, as for instance follows: the bottom side of the triangular light guide 1 has extensions formed from its opposite ends, and the triangular light guide 1 is fixed to the front panel 4 by fastening the opposite extensions to the front panel with screws. In this modification the bottom side of the triangular plate 1 is stripe-masked to form windows.

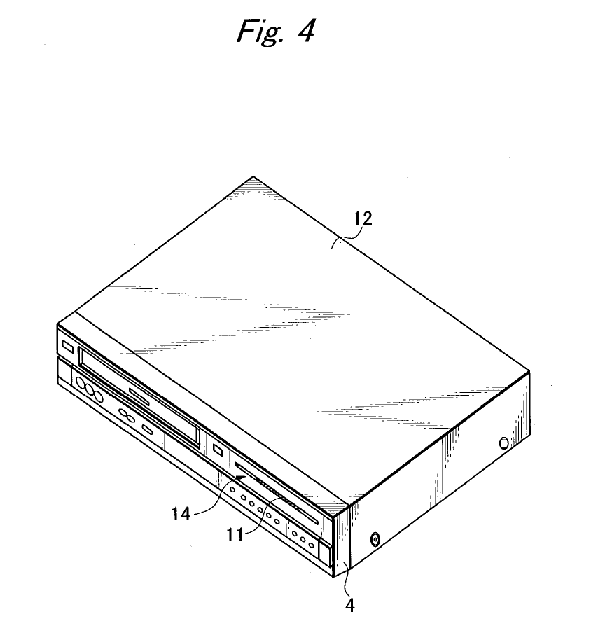

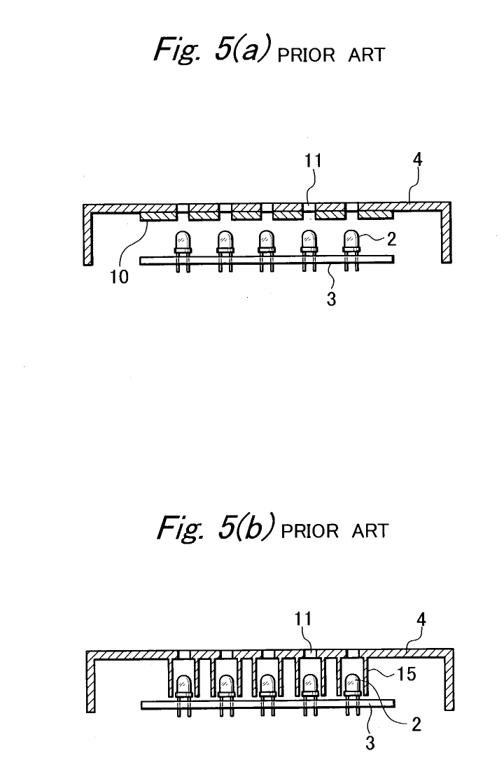

Referring to FIGS. 3(a), 3(b) and 3(c), three recess versions each made on the apex of the triangular plate are shown, circular arc, elliptic and polygonal recesses respectively. The shape of the recess is dependent on the kind and intensity of the light source used, and no matter what shape the recess may have, the recess needs to be so shaped that all windows 11 may be illuminated evenly.

The equilateral triangular plate 1 may have apertures made therein to make all windows 11 to be evenly illuminated. The size and location of each aperture is determined cut-and-try to provide the even illumination of all windows.

The equilateral triangular light guide whose recessed apex has a light source placed therein according to the present invention provides following advantages:

a single light source permits all windows to be illuminated evenly;

the fine irregular curved surface of the recess and the fine irregular surfaces of the opposite oblique and bottom sides of the triangular plate causes effective diffusion and dispersion of the light from the single light source within the triangular plate, assuring that all windows be illuminated evenly, and that all windows be visible from oblique angles of sight relative to the front of the display device; and

a single light source and a least number of associated parts are used to cause the significant reduction of assembling and manufacturing cost, and the significant reduction of power consumption and running cost.

What is claimed is:

1. A display device for use in displaying how an electronics device works or what pieces of information are sent or received, comprising: a triangular, light guide plate of a transparent material, the triangular plate having a recess formed on its apex and a plurality of windows formed on its bottom side, separated by masking at intervals; and a light source placed in the recess of the triangular plate, whereby the windows may be illuminated by the light from the light source.

2. A display device according to claim 1, wherein the recess is finely irregular on its surface.

3. A display device according to claim 1, wherein the triangular plate is finely irregular on its oblique sides.

4. A display device according to claim 1, wherein the triangular plate is finely irregular on its bottom side to provide the finely irregular-surfaced windows.

5. A display device according to claim 1, wherein it further comprises a bottom plate, which is fastened to the bottom side of the triangular plate at right angles.

6. A display device according to claim 1, 2, 3, 4 or 5 wherein the triangular plate has apertures made therein to make all windows to be evenly illuminated.

7. A light guide plate for guiding the light from a light source to the windows of a display device, thereby displaying how an electronics device works or what pieces of information are sent or received, comprising: a triangular plate of a transparent material, the triangular plate having a recess formed on its apex to contain the light source, the windows being formed on the bottom side of the triangular plate, separated by masking at intervals.

8. A light guide plate according to claim 7, wherein the recess, opposite oblique sides and bottom side of the triangular plate are finely irregular on their surfaces.

9. A light guide plate according to claim 7 or 8, wherein it further comprises a bottom plate, which is fastened to the bottom side of the triangular plate at right angles.
